(19) United States
(12) Patent Application Publication
(10) Pub. No.: US 2008/0117210 A1
(43) Pub. Date: May 22, 2008

(54) VIRTUAL ENDOSCOPY

(75) Inventors: Marco Razeto, Edinburgh (GB); Ian Poole, Edinburgh (GB)

Correspondence Address: RENNER OTTO BOISSELLE & SKLAR, LLP, 1621 EUCLID AVENUE, NINETEENTH FLOOR, CLEVELAND, OH, 44115, US

(73) Assignee: Barco N.V., Kortrijk (BE)

(21) Appl. No.: 11/562,744

(22) Filed: Nov. 22, 2006

(51) Int. Cl. G06T 17/00

(52) U.S. Cl. 345/424

(57) ABSTRACT

A method for automatically determining a start or finish location near to an end of a lumen in a medical image data set is described. The location may thus be used in determining a camera path for virtual endoscopy (e.g. colonoscopy). The data set comprises a plurality of voxels arranged along first, second and third directions and the method includes: segmenting the data set to identity a group of voxels classified as belonging to the lumen; selecting one of the axes of the data set as a primary direction based on an expected direction of the lumen at the end of interest; selecting a slice through the data set which is perpendicular to the primary direction and includes voxels at a spatial extremity of the group of voxels classified as belonging to the lumen along this direction; identifying a two-dimensional (2D) region of the voxels classified as belonging to the lumen within the selected slice; and selecting, based on the position of the 2D region, a position within the data set as the terminal location for the virtual colonoscopy camera path.

### BACKGROUND ART

The invention relates to the virtual endoscopy, and in particular to determining a start or end point for navigating a virtual endoscope through a biological object with a lumen.

Traditional endoscopy involves the use of an endoscope which is inserted into a patient to allow direct visual inspection of, for example, the colon. The technique is relatively invasive and uncomfortable, and often requires heavy patient sedation. Accordingly, virtual endoscopy, which is based on an analysis of medical image data (computer simulated endoscopy), is often preferred.

Patient medical imaging methods, such as computer-assisted tomography (CT), magnetic resonance imaging (MRI), ultrasound and positron-emission tomography (PET), generate large three-dimensional (3D) volume data sets representing all or part of a patient's body. These volume data sets are highly detailed and allow complex studies of the body to be made. Virtual endoscopy is a technique in which a virtual camera is made to travel along a biological object with a lumen such as a colon, blood vessel or bronchial tree, with the image of the lumen that is seen by the virtual camera presented to a user for diagnostic and other purposes. Virtual endoscopy is less invasive for the patient and also provides the clinician with a much greater degree of flexibility in the way he can view the lumen of interest. For example, the clinician can choose to observe the virtual lumen from almost any direction (from both inside and outside the lumen), and can easily zoom-in and -out of regions considered to be of particular interest.

A common analysis technique for medical image data is therefore to render a series of two-dimensional images from the viewpoint of a camera travelling along a path within a lumen of interest, thus providing a virtual “fly-through” of the lumen. To navigate the viewpoint through the lumen, a path for the virtual camera to follow is often determined in advance because even experienced clinicians can have difficulty in manually controlling the camera movement in real time.

A number of methods have been proposed for calculating suitable paths for the camera to follow. These paths are frequently referred to as centerlines because they are usually designed to follow as closely as possible a central route through the lumen. Methods for calculating suitable paths include those based on mathematical techniques designed for wall avoidance [1, 2], those based on mathematical techniques that use erosion to determine a centerline along a lumen [3], those based on labeling points in the data set with their distance from an end of the path using a wavefront model to avoid obstacles and calculating the path by moving from point to point according to the closest distance to the end point [4], those based on obtaining an initial path by using a distance label map to connect start and end voxels in the data set via intermediate voxels according to their distance from the start and end voxels, and then centering the path using maximum diameter spheres [5, 6], and those based on determining navigation steps by using ray casting to find the longest ray from a camera position to the wall and weighting this with the existing viewing direction of the camera to obtain a new direction for movement of the camera, and repeating this for each step [7]. General data collection and processing methods for viewing three-dimensional patient images have also been described [8, 9]. A number of commercial virtual endoscopy systems and the various approaches taken to camera navigation and to the image processing necessary to represent a realistic view of the lumen are discussed by Bartz [10].

One fundamental step in techniques of virtual endoscopy is that of identifying a suitable starting point from which to begin the camera fly-through, and possibly also an ending point (i.e. the start and end locations for the centreline). A common way of doing this is to provide the user with an overview image of the data set rendered in such a way that the anatomical feature of interest is apparent (other anatomical features may also be apparent to help orient the user's understanding of the image). The user is thus able to readily identify the lumen of interest and select an appropriate start point for the centreline calculation within the lumen, e.g. by “clicking” with a pointer such as a mouse. A corresponding voxel in the 3D data set can then be determined and an appropriate centreline starting from this voxel calculated.

This approach is relatively reliable, but has the disadvantage of requiring clinician input to identify the start voxel. Automation is generally preferred for medical image data pre-processing since this saves clinician time, both in terms of the clinician having to take part in the pre-processing itself, and also in terms of the clinician having to wait for the results of the pre-processing before continuing his analysis. Furthermore, automation can help improve objectivity and reproducibility in the analysis because a possible source of clinician subjectivity is removed.

Accordingly, in some of the above-mentioned methods for calculating suitable paths for a virtual camera to follow, a start point is determined automatically. This is typically done by calculating a camera path based on the 3D extent of the biological structure of interest (e.g., by erosion), and then taking the position where the path intersects with a boundary as a start point

However, a drawback of this approach is that the determined initial viewpoint will often not correspond with the optimal position for the start of a review of the data (i.e. a virtual colonoscopy flythrough). The start point will often be at the lowest point of the insufflation probe, in which case the virtual camera's field of view would be occluded by the material of the insufflation probe and colonic wail The start point determined in this way will also in general not be at a central location if the centerline algorithm has extended the line arbitrarily into the founded end of the rectum.

Another drawback is that starting points located through centerline calculations require at least some of the centerline to be determined in advance, which is computationally intensive. Furthermore, some methods of flythrough navigation (e.g. as described in WO 03/054803 [7]) do not rely on pre-calculating a centerline to determine the flight path and so the above described method for automatically determine a starting point cannot be used.

Accordingly, there is a need for as improved automatic method for identifying an appropriate start and/or end point for virtual endoscopy of a lumen.

### SUMMARY OF THE INVENTION

According to a first aspect of the invention there is provided a method for automatically determining a terminal location for a virtual endoscopy camera path near an end of a lumen in a biological structure, the biological structure represented by a three-dimensional volume data set comprising a plurality of voxels arranged along first second and third directions, the method comprising: segmenting the data set to identify a group of voxels classified as belonging to the lumen; selecting one of the first, second or third directions as a primary direction in accordance with an expected direction of the lumen at its end; selecting a slice through the data set which is perpendicular to the primary direction and includes voxels at a spatial extremity of the group of voxels classified as belonging to the lumen along this direction; identifying a two-dimensional (2D) region of the voxels classified as belonging to the lumen within the selected slice; and selecting a position within the data set as the terminal location for the virtual colonoscopy camera path based on the position of the 2D region in the data set.

For example, the position for the terminal location may be selected as being within the plane of the 2D region. For example, the terminal location may be at a centre of the 2D region, e.g. at a location within the plane of the 2D region having the greatest distance from the nearest edge, or a “centre-of-mass” of the 2D region. In some examples, the terminal location need not be within the plane of the 2D region, but may be at a position determined from a 3D section of the lumen in the vicinity of the 2D region. For example, in colonoscopy studies, the 3D section may be a sub-volume of the data set determined to correspond to the rectum by virtue of the sub-volume being connected to the 2D region. The terminal location may then be at a central point in the sub-volume. This central point may similarly be the point having the furthest distance from the nearest boundary of the 3D sub-volume, or at a “centre-of-mass” of the sub-volume.

Thus a simple and reliable method for automatically determining either a start or a finish location (i.e. a terminal location) for a virtual endoscopy camera path is provided. Because the method relies on identifying a spatial extremity of the lumen in the data set, the method is less likely to lead to portions of the lumen being missed because of obstructions in the lumen.

In the event there are multiple 2D regions of voxels classified as belonging to the lumen in the selected slice, the 2D region identified in step (d) may be the largest of these. Alternatively, it may be the one nearest to the particular part of the slice, e.g. the centre, or possibly even simply one which is randomly selected if only a coarse initial estimate is required.

The method may include an additional step to be performed after identifying the 2D region in the selected slice of determining whether the 2D region meets at least one pre-determined criterion, and if not, re-classifying the voxels in the 2D region as not belonging to the lumen of interest, and returning to the step of selecting a slice through the data set including voxels at a spatial extremity of the group of voxels for another iteration of this step which takes account of the modified classification of the voxels belonging to the lumen.

This additional step is useful where there is a risk that the segmentation step will wrongly classify some voxels as belonging to the lumen of interest, but where it is possible to distinguish a 2D region in the slice likely to be associated with wrongly classified voxels based on one or more other criteria, for example, size or position within the slice. These voxels can then be re-classified as not belonging to the lumen of interest, and another 2D domain in another or the same slice identified. In some cases only the voxels within the identified 2D region will be re-classified as not belonging to lumen of interest. This means the selected slice in the next iteration could be the same slice again, i.e., if there is another region of voxels within the slice which remains classified as belonging to the lumen of interest. In other examples, all of the voxels in the selected slice may be re-classified as not belonging to the lumen irrespective of whether they are in the 2D region of voxels previously identified, or elsewhere in the slice. This means a different slice will be selected in the next iteration because the present slice no longer includes voxels classified as belonging to the lumen of interest (and as such does not intersect with fee extremity of the group of voxels classified as belonging to the lumen).

The at least one criterion may be that the 2D region of voxels is larger than a threshold size. In such cases, the threshold size may be chosen to be smaller than the expected size of the lumen, but larger than the typical size of a medical probe inserted into the lumen during acquisition of the data set.

This is useful because a medical probe, for example an anal probe inserted into a patient for colon sufflation during data acquisition, can frequently be wrongly classified as belonging to the lumen. Thus by requiring an identified 2D region to be larger than the size of a typical probe for the application at hand, there is reduced risk of a start/finish point being automatically determined as being within the probe.

In other examples, the at least one criterion may be that the 2D region of voxels is located within a pre-determined portion of the selected slice. This criterion may be the only criterion, or may be in addition to one or more other criteria, e.g. based on size.

A criterion based on the position of the 2D region within the slice can be useful in cases where voxels which are likely to be wrongly classified as belonging to the lumen of interest during the segmentation typically occur in a different location in the slice than the lumen of interest. For example, for virtual colonoscopy, the lumen of interest (i.e., the colon) is likely to be relatively central In the selected slice. Other artefacts that may be wrongly classified as colon, for example artificial hips, will, on the other hand, be less central. Thus if the pre-determined portion is chosen to be a central portion of the selected slice, e.g., a central portion having a fractional area of around 20%, 25%, 30%, 35%, 40%, 45% or 50%, or so of the area of the selected slice, any artificial hip apparent in the selected slice is likely to occur outside of this central portion, and so be re-classified as not belonging because of its failure to meet the set criterion of being within a central portion of the slice.

The pre-determined portion may be rectangular. For example, the portion may have a dimension which is greater in a direction normal to a coronal plane in the data set than in a direction normal to a sagittal plane in the data set. This assists in excluding artefacts which are typically offset from the colon in a direction normal to a sagittal plane, e.g. artificial hips, without unduly restricting the variation in colon position along a direction normal to a coronal plane that mar arise before the colon falls outside the pre-determined portion of the data.

According to another aspect of the invention there is provide a method of automatically determining a virtual endoscopy camera path, the method comprising determining a terminal location for the camera path using a method according the first aspect of the invention, and calculating a camera path that starts or finishes at the terminal location. The camera path may be determined using any known technique, for example any of the techniques referred to above [1, 2, 3, 4, 5, 6, 7].

Another aspect of the invention provides a method of performing virtual endoscopy comprising determining a terminal location for a virtual endoscopy camera path using a method according the first aspect of the invention, calculating a camera path that starts or finishes at the terminal location, rendering a sequence of images of the lumen boundary from viewpoints at different locations along the camera path, and displaying the sequence of images to a user.

According to another aspect of the invention there is provided a computer program product comprising machine-readable instructions for implementing the method of the first aspect of the invention.

The computer program product may comprise a computer program on a carrier medium, for example a storage medium or a transmissions medium.

According to another aspect of the invention there is provided a computer configured to perform the method of the first aspect of the invention.

According to another aspect of the invention there is provided an apparatus for automatically determining a terminal location for a virtual endoscopy camera path near to an end of a lumen in a biological structure, the biological structure represented by a three-dimensional volume data set comprising a plurality of voxels arranged along first, second and third directions, the apparatus comprising a processing unit coupled to a source of medical image data and operable to load a data set from the source of medical image data; segment the data set to identify a group of voxels classified as belonging to the lumen; select one of the first, second or third directions as a primary direction in accordance with an expected direction of the lumen at its end; select a slice through the data set which is perpendicular to the primary direction and includes voxels at a spatial extremity of the group of voxels classified as belonging to the lumen along this direction; identify a two-dimensional (2D) region of the voxels classified as belonging to the lumen within the selected slice; and select a position within the data set as the terminal location for the virtual colonoscopy camera path based on the position of the 2D region in the data set.

### BRIEF DESCRIPTION OF THE DRAWINGS

For a better understanding of the invention and to show how the same may be carried into effect reference is now made by way of example to the accompanying drawings in which:

FIG. 1 schematically shows a generic x-ray CT scanner for generating volume data sets for processing in accordance with embodiments of the invention;

FIG. 2 schematically shows the anatomy of a human digestive tract;

FIG. 3 schematically shows a 2D image rendered from a 3D volume data set of the kind suitable for virtual colonoscopy;

FIG. 4 is a flow chart schematically showing a method of identifying a start location for a virtual colonoscopy camera path according to an embodiment of the invention;

FIGS. 5A, 5B and 5C schematically show transverse cross-sections through a 3D volume data set of the kind suitable for virtual colonoscopy;

FIG. 6 schematically shows a general purpose computer system configured to process volume data sets in accordance with embodiments of the invention; and

FIG. 7 shows an example computer network that can be used in conjunction with embodiments of the invention.

### DETAILED DESCRIPTION

Virtual endoscopy is often used in the study of the colon. In this context virtual endoscopy is often referred to as virtual colonoscopy. Embodiments of the invention will hereafter be described by way of example in the specific context of virtual colonoscopy. However, it will be understood that embodiments of the invention may equally be employed in other applications of virtual endoscopy, and also in computer simulated fly-throughs of biological structures which are not normally the subject of conventional endoscopy procedures.

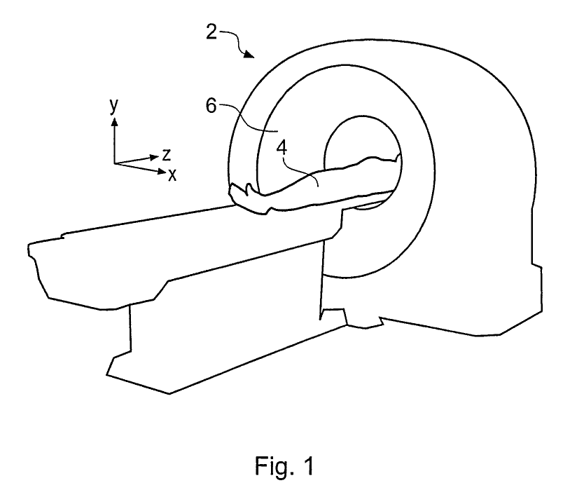

FIG. 1 is a schematic perspective view of a generic x-ray CT scanner 2 for obtaining a three-dimensional (3D) scan of a patient 4 to provide data suitable for virtual colonoscopy. The patient's abdominal region is placed within a circular opening 6 of the CT scanner 2 and a series of x-ray images are taken from directions around the patient. The raw image data are combined using tomographic techniques to produce a volume data set. The volume data set comprises a collection of voxels. Conventionally, the volume data, set is aligned with transverse, sagittal and coronal planes. Thus a Cartesian coordinate system may be defined in which the xy-axes are in a transverse plane, the xz-axes are in a coronal plane and the yz-axes are in a sagittal plane. The conventional orientations for the x, y and z-axes relative to the patient are schematically shown to the top left of FIG. 1. In this orientation the z-axis increases from the patient's feet to his head (i.e. inferior to superior), the x-axis increases from the patient's left to his right, and the y-axis increases from the patient's rear to his front (posterior to anterior). Thus transverse planes are slices of the data set arranged normally to the z-direction, sagittal planes are slices of the data set arranged normally to the x-direction, and coronal planes are slices of the data set arranged normally to the y-direction.

Each voxel in the volume data set has a signal value associated with a physical parameter of the corresponding portion of the scanned object. For a CT scan, the signal value (or image parameter) for a given voxel is a measure of how much the corresponding portion of the patient's body absorbs x-rays. The image parameter may thus be referred to as radiodensity. Radiodensity is conventionally calibrated according to the Hounsfield scale. The Hounsfield scale is defined such that air has a radiodensity of −1000 HU (Hounsfield units) and water has a radiodensity of 0 HU, Typical radiodensity values for other materials are −50 HU for body fat, +40 HU for soft tissue, such as muscle, and +1000 HU for bone.

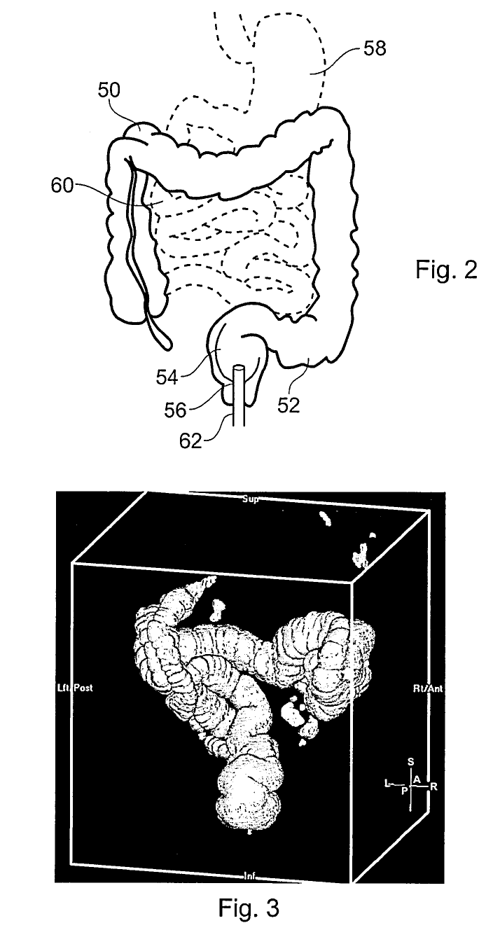

FIG. 2 is a schematic diagram showing the anatomy of a human digestive tract. The main components apparent in the figure are a large intestine 50, a sigmoid colon 52, a rectum 54, an anus 56, a stomach 58 and a small intestine 60. In a typical colonoscopy screening procedure (whether real or virtual), a clinician will normally start at the anus 56 and view the digestive tract along a path passing through at least the rectum 54, sigmoid colon 52 and large intestine 50. For simplicity, the parts of a patient's anatomy that are typically viewed during a colonoscopy procedure will be collectively be referred to here as the colon. Thus the term should be understood accordingly unless the context demands otherwise, it being understood that this interpretation may not be correspond exactly with a strict medical definition of the term.

To obtain data suitable for virtual colonoscopy the patient will normally have undergone a colonic lavage and sufflation procedure prior to scanning. This means, at least so far as possible, the colon is full of gas and free of obstructions while the image data are obtained. This ensures the extent of the colon is readily apparent in the medical image volume data set. For example, for a data set from a CT scanner such as shown in FIG. 1, the colon will be associated with voxels having low radiodensities, for example less than around −600 HU or so. This is because the gas in the colon is a relatively poor absorber of x-rays. The colonic walls and surrounding body tissue, on the other hand, will have greater radiodensities, for example closer to 0 HU, or denser. To ensure the colon remains sufflated during scanning (i.e. the process of obtaining the data), the sufflation probe is usually left in place. An in-situ sufflation probe 62 is schematically shown in FIG. 2.

FIG. 3 schematically shows a 2D image rendered from a 3D volume data set of the kind suitable for virtual colonoscopy. The orientation of the axes of the volume data set with respect to the image are apparent from the projected cube-frame outline seen near to the boundaries of the image. The 2D image in FIG. 3 is rendered so that voxels corresponding gas are rendered opaque and all other voxels are rendered transparent. Thus the colon appears as if it were a solid structure inside an otherwise invisible patient. The view shown in FIG. 3 is taken from a direction which is broadly from behind the patient, and the patient is broadly upright in the image. Thus, the patient's rectum is apparent as the relatively large bulbous feature at the bottom-centre of the image. A small section of the sufflation probe can also be seen in FIG. 3 as a stub-like extension at the lowest part of the colon. It is noted that the section of the sufflation probe apparent in the FIG. 2 will correspond with the hollow core of the sufflation probe. This is because this part of the probe will be full of gas and so rendered opaque in the image.

It is clear from FIGS. 2 and 3 that colon is a complex and non-uniform structure. This is what makes automatic processing of medical image data of the colon and, similar lumen structures, subject to difficulty.

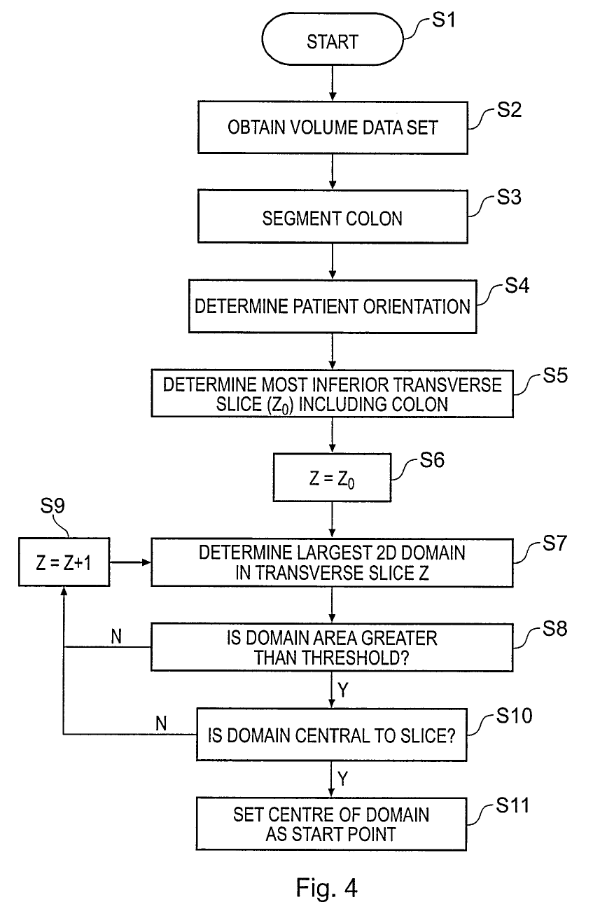

FIG. 4 is a flow chart schematically showing a method of identifying a start location for a virtual colonoscopy camera path according to an embodiment of the invention. A general purpose computer system may, for example, be configured to is execute the method. For virtual colonoscopy the most appropriate starting point will be at, or near to, the patient's anus. This is because this is the position at which conventional colonoscopy examinations would usually begin. Accordingly the method shown in FIG. 4 is for automatically determining a starting point at a position near to the anus.

Processing starts at step S1.

In step S2, a volume data set is obtained. In this example a previously recorded volume data set is retrieved from storage on a hard disk drive of a computer system configured to perform the method. In other examples the data set may be retrieved over a network, for example a Picture Archiving and Communication System (PACS) network. Alternatively, the volume data may be obtained directly from an imaging modality, for example the CT scantier shown in FIG. 1, immediately following a scan of a patient.

In step S3, the data set is segmented to identify voxels in the data set which are deemed to correspond to the colon. There are many well known methods for classifying voxels in a data set according to tissue type/anatomical feature (i.e. for performing segmentation). Any known segmentation scheme may be used. For example, the automatic segmentation schemes described by Wyatt et al. in “Automatic Segmentation of the Colon for Virtual Colonoscopy” [11] or Frimmel et al. in “Centerline-based Colon Segmentation for CT Colonography” [12] could be used. The result of the segmentation step is thus a data structure (e.g. a mask) that identifies voxels in the data set which are deemed to correspond to the colon.

In step S4, the orientation of the patient with respect to the axes of the volume data set is determined. This may be determined from the contents of a standard file header for the medical image data file, for example. Step S4 therefore allows the orientation of the planes and the patient in the data set to be determined (to the extent these are not already known, e.g., because they are standardised for the study at hand). Thus step S4 provides information on which planes of the data set most closely correspond with transverse, sagittal and coronal planes through the patient, and also which directions in the data set are towards the patient's left, right, inferior, superior, posterior and anterior.

In step S5, the most inferior transverse plane of the volume data set which intersects the segmented colon is determined (i.e. the transverse plane intersecting the most inferior voxels classified as belonging to the colon in the segmentation step). The position of this plane can be found, for example, by identifying the minimum z-coordinate associated with the voxels classified as corresponding to the colon in the segmentation at step S3. The reason for seeking a transverse plane is that a transverse plane is the closest of the planes to being normal to a direction of extent of the colon at the desired starting point. Thus a cross-section of the lumen of interest (colon) at the desired start point (anus) is most closely aligned with a transverse plane. The reason for starting with the inferior-most plane is that this is the end of the lumen of interest at which the desired starting point is located. The inferior-most transverse plane intersecting the segmented colon is taken here to be the transverse plane having coordinate Zₒ.

In step S6, an indexing parameter Z is set to Zₒ.

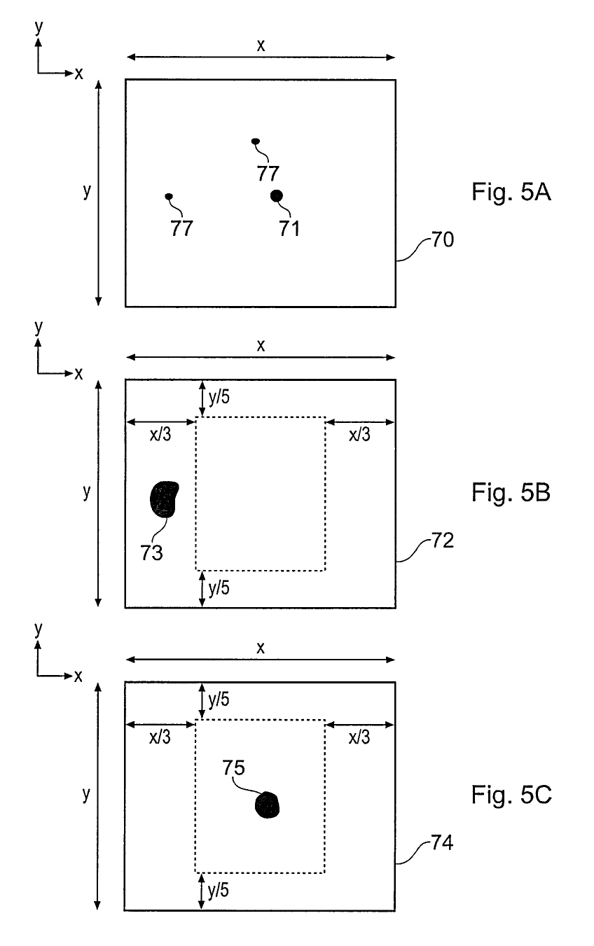

FIG. 5A shows an image 70 schematically representing the transverse plane of voxels (i.e. transverse slice) at z-coordinate Z (i.e. Zₒ for this iteration). The directions associated with the x- and y-axes of the volume data set are shown in the top left corner of the figure. Thus the Image 70 is oriented relative to the patient so that that the left of the patient is in the left of the image, the right of the patient is in the right of the image, the posterior direction is down, the anterior direction is up, the inferior direction (towards patient's feet) is into the plane of the image and the superior direction is out of the plane of the image. The volume data set has a width of X voxels along the x-direction and a height of Y voxels along the y-direction. For a typical medical image volume data set from a CT scanner, X and Y may be 512 or 1024, for example. The image in FIG. 5A is shown so that voxels not classified as belonging to the colon in step S3 are represented in white and voxels classified as belonging to the colon in step S3 are represented in black.

In step S7, connected 2D domains (regions) of voxels classified as belonging to the colon in the transverse slice at coordinate z=Z are identified. The largest connected 2D domain is selected for further processing. The connected 2D domains in the slice can be identified using any convention connected-region finding algorithm, for example a disjoint sets algorithm [13].

For the example Image shown in FIG. 5A, three separate connected regions is of voxels classified as belonging to the colon are identified. These are two small regions identified by reference numeral 77 and a larger, though still relatively small region, identified by reference, numeral 71. The two small, regions identified by reference numeral 77 do not belong to the colon. These are artefacts arising from the segmentation routine employed at step S3 not being perfect in classifying which voxels as belonging to the colon. The larger region identified by reference numeral 71 also does not belong to the colon. This region corresponds with the hollow part of the sufflation probe. This is also appears in FIG. 5A because of limitations in the segmentation step's ability to perfectly segment the colon. Imperfect segmentation is typical for automated segmentation routines. Since the domain identified by reference numeral 71 is the largest, it is the one selected here for further processing. The smaller domains identified by reference numeral 77 are discounted from further processing in this example.

In step S8, the areal extent A of the domain selected in step S7 within the transverse plane is determined (e.g. by counting the number of voxels comprising it). The area A is compared with a threshold value Aₜₕ. The purpose of this step is to determine whether the domain selected at step S7 corresponds to the hollow part of the sufflation probe (or other device inserted into a lumen opening in non-colonic applications), or other artefact. Thus a suitable value for Aₜₕ will depend on the expected size of the lumen at the desired starting point, and the expected size of other artefacts likely to appear in the image, but which do not belong to the lumen of interest. For example, in virtual colonoscopy, the diameter of the sufflation probe might be on the order of 5 to 10 mm or so. Thus the area of the probe would typically be around 100 to 300 mm². For typical imaging resolutions, this would correspond to perhaps somewhere between 500 and 1000 voxels, for example. Thus a suitable value for Aₜₕ may be a few times larger than this, e.g., 2, 3, 4 or 5 times larger. Aₜₕ may be defined in units of numbers of voxels, mm², or any other unit.

If in step S8 it is determined that A is less than Aₜₕ, the domain selected for further processing in step S7 is deemed not to correspond to the anus (because it Is too small), and processing follows the N branch to step S9. In step S9 the indexing parameter Z is incremented by one and processing returns to step S7 for another iteration. By incrementing Z in this way, processing in this next iteration through step S7 is made on the next transverse slice through the data set. That is to say, the most inferior transverse slice considered in first iteration through step S7 is replaced with the next-most inferior slice in the second iteration, and so on.

If in step S8 it is determined that A is greater than Aₜₕ, processing follows the Y branch to step S10.

In step S10, it is determined whether or not the domain selected in step S7 occurs within a pre-determined portion of the transverse data slice. If it does not (i.e. if it occurs outside of the portion), it is assumed that the domain does not belong to the colon. This step can be useful in embodiments where there is a risk that relatively large non-colonic structures will wrongly be classified as belonging to the colon in the segmentation at step S3, but where it is known that these non-colonic structures will typically occur away from a portion of the transverse slice in which the desired starting point is expected to occur.

For example, data sets for virtual colonoscopy are generally obtained in such a way that the anus (taken here to be the desired starting point) will typically be in a central portion of a transverse slice through the volume data set (i.e. towards the centre of an image such as that shown in FIG. 5A). However, an artificial hip, for example, will generally closer to one or other sagittal boundary of the data set. An artificial hip can sometimes be erroneously classified as belonging to the colon by automatic segmentation techniques. (This can arise because the signal values for voxels corresponding to the artificial hip saturate due to the hip's high radiodensity. This can cause processing artefacts which make the hip appear as a void, rather than a solid structure. Thus the artificial hip can appear similar to a gas-filled region, and be wrongly classified as part of the sufflated colon. It is noted that similar effects can cause the wails of a sufflation probe, as well as the hollow within in, to also be wrongly classified as colon.)

In the present embodiment, the pre-determined portion is defined by a rectangle centred on the middle of the slice. The rectangle has a width in the x-direction of X/3 (i.e. one third of the overall extent of the volume data set in this direction), and a height in the y-direction of 3Y/5 (i.e. three fifths of the overall extent of the volume data set in this direction).

FIG. 5B is similar to, and will be understood, from FIG. 5A. However, FIG. 5B shows an image 72 from a patient with an artificial hip. The artificial hip has been wrongly classified in step S3 as belonging to the colon, and furthermore has been selected in step S7 as the largest connected domain in the transverse slice under consideration. The region identified by reference numeral 73 thus corresponds with the patient's artificial hip. The extent of the pre-determined central portion of the transverse slice is identified in FIG. 5B by the dashed-line rectangle. It can be seen that the domain corresponding to the artificial hip (identified by reference numeral 73) is outside of the central portion, whereas the anus would normally be expected to be located inside the central portion.

Thus, if it is determined in step S10 that the domain selected in step S7 is not contained within the central portion of the slice (e.g. as shown In FIG. 5B), the region is deemed to have been wrongly classified as belonging to the colon. Processing then follows the N branch from step S10 back to step S9. As discussed above, in step S9 the indexing parameter Z is incremented by one, and processing returns to step S7 for another iteration. As before, by incrementing Z, processing in the subsequent iteration through step S7 is made on the next transverse slice through the data set. That is to say, the next-most inferior transverse slice to the one previously considered.

If, on the other hand, it is determined in step S10 that the domain (region) previously selected in step S7 is contained within the central portion of the slice, the region, is not deemed to have been wrongly classified as belonging to the colon, and processing continues along the Y branch to step S11. The inventors have found for a central portion having the above-described dimensions, good results are obtained if the 2D region is deemed to be within the central portion if any part of it is within the portion. Similar results may be obtained for a larger central portion if all, or a predetermined significant fraction, of the 2D region is required to be within the central portion for processing to follow Y branch to step S11.

The specific dimensions of the central portion shown in FIG. 5B have been found to be suitable in distinguishing between a transverse section through an artificial hip and a transverse section through the anus. It may be noted that the width, of the pre-determined central portion in the x-direction is smaller than the height of the pre-determined portion in the y-direction. This is because the hip will typically be to either the left or right of the anus. The inventors have found it can also beneficial to restrict the central portion along the y-direction. This can help in rejecting left-over portions of the patient support table, air pockets in clothing and parts of a heavily folded colon, as well as allowing for unusual patient orientations in the data set.

FIG. 5C is similar to and will be understood from FIG. 5B. However, FIG. 5C shows an image 72 corresponding to a transverse slice through the data set in which the region selected In step S7, indicated by reference numeral 75, is within the central portion of the transverse plane (and furthermore has previously been determined in step S8 as having an area greater than Aₜₕ). In this case processing proceeds along the Y branch to step S11.

The result of the processing up to and including step S10 is an identification of the inferior-most transverse plane that includes a connected domain of voxels classified in the initial segmentation as belonging to the colon, where the domain has an area greater than a threshold value Aₜₕ and is confined to a central portion of the volume data set.

The voxels comprising the 2D domain are taken to represent a transverse cross-section through the anus. Thus, referring to FIG. 5C, the 2D domain identified by the reference numeral 75 is taken to be a cross-section through the lumen of interest ion the vicinity of the desired starting point.

In step S11, a position within the 2D domain is taken as corresponding with the desired starting point. In this example, the calculated starting point is taken to be at the centre of the identified 2D domain at coordinates (Xₛₜₐᵣₜ, Yₛₜₐᵣₜ). The centre of the 2D domain is defined here to be the position in the domain having the greatest distance from the boundary of the domain. This can be calculated using conventional techniques, for example, chamfer distance transform techniques. In other examples, the start point may be taken to be at centre-of-mass of the 2D domain, or simply at a position midway between the minimum x- and y-coordinates for the group of voxels forming the domain.

Thus the start point for the automatic fly deemed to correspond with the desired starting point, i.e. the anus, is taken to be at position (Xₛₜₐᵣₜ, Yₛₜₐᵣₜ, Zₛₜₐᵣₜ), where Xₛₜₐᵣₜ and Yₛₜₐᵣₜ are as defined above, and Zₛₜₐᵣₜ is equal to the value of the incrementing parameter Z when processing reaches step S11 (i.e. the z-coordinate of the inferior-most transverse plane that includes a connected domain of voxels classified in step S3 as belonging to the colon, and having an area greater than a threshold value and confined to a central portion of the volume data set).

Once the start point has been determined, any conventional centreline calculating algorithm may be employed to determine a suitable camera path from this start point.

It will be appreciated that the method shown in FIG. 4 may be modified in other embodiments.

For example, not all of the steps will be appropriate in all embodiments. For example, if the desired start point of the lumen of interest is not likely to be confused with another structure in a different part of the data set, there is no need to include a step corresponding to step S10. If there are no medical probes involved, it may not be necessary to perform a step corresponding to step S8. If the orientation of the patient relative to the planes of the volume data is standardised for the study at hand (i.e. fixed in advance) there will be no need to perform a step corresponding to step S4.

Furthermore the steps need not be performed in the order shown in FIG. 4. For example Steps S8 and S10 could be reversed with no effect on the results of the processing. However, it will be appreciated that although the order of some of the steps is not important, some steps should be performed in order relative to each other. For example, step S7 should be performed before step S8 (and before steps S10 and S11 to the extent these steps are performed in any given iteration, i.e. to the extent that processing does not return to step S7 via step S9 before step S10 or step S11 are reached).

The specific way in which the steps are performed could also be modified. For example, similar results could be achieved In step S10 by having a relatively large central portion, but requiring the selected domain to be wholly within it for processing to follow the Y branch to step S11, as would be achieved if the central portion is relatively small, but the with the selected domain required to only be partially within it for processing to follow the Y branch.

In some embodiments step S7 may be omitted so that steps similar to steps S8 and S10 are performed for all connected 2D domains, and not only the largest. Only if none of these 2D domains have areas greater than Aₜₕ, or none are within the predetermined central portion, will processing return to step corresponding to S7 via a step corresponding to step S9. This approach may have the advantage of calculating a start point in a more inferior data slice in which the anus is first apparent as a domain in the central portion having an area greater than even if there is a larger domain corresponding to hip that is outside the central portion.

Furthermore, in step S10 the processing may not turn on a central portion of the data slice, but may instead turn on a different portion of the slice. For example, in an implementation of the method for finding a suitable starting point in a lumen of the left lung, a step corresponding to step S10 may be performed but modified to determined whether the domain being considered in a left or a right portion of the data slice (as opposed to a central or non-central portion). If the domain is in a left portion of the data slice, processing may continue to step S11. If the domain is in a right portion, processing may return to step S7 (via step S9) for another iteration. Thus shape and size of the pre-determined portion will depend on the application at hand, and in particular the expected relative placements of the desired starting point being sought and the structures likely to be problematic (i.e. because it is known they can be readily misclassified as relating to the lumen of interest).

For other lumens (e.g. bronchial tree, blood vessel etc.), the step at S5 will be modified according to the desired start point (e.g. trachea) and lumen of interest. The selected plane will depend on the expected plane of the lumen at the desired starting point (i.e. transverse (as for the anus), sagittal or coronal), and which end of the lumen the fly through should start from (i.e. inferior or superior for a transverse plane, left or right for a sagittal plane, or anterior or posterior for a coronal plane). In some cases reformatting may be performed to transfer the data set to a different coordinate space so that the expected plane of the lumen at the desired starting point is closer to a plane of the reformatted data set (i.e. planes other than the conventional transverse, sagittal and coronal may be used). However, in general it is not considered that this will normally be necessary.

While the above description has primarily referred to data, from a CT scanner, it will be appreciated that the data could equal be obtained from other imaging modalities, for example a magnetic resonance (MR) scanner, a positron-emission tomography (PET) scanner, or an ultrasound scanner.

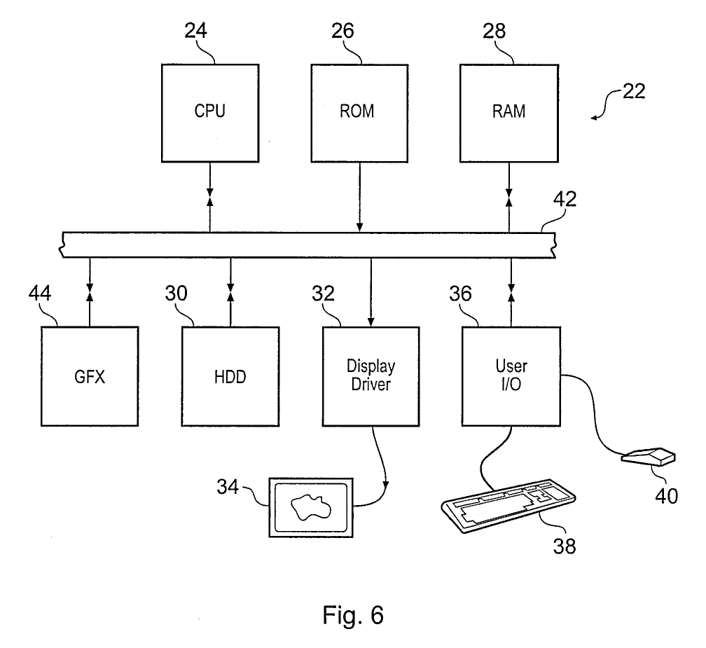

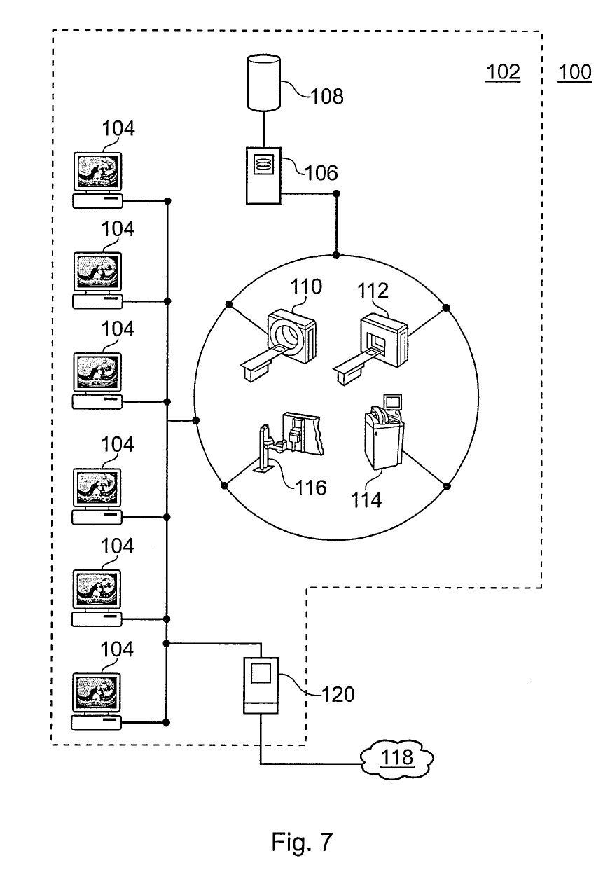

FIG. 6 schematically illustrates a general purpose computer system 22 configured to perform processing of volume data in accordance with an embodiment of the invention. The computer 22 includes a central processing unit (CPU) 24, a read only memory (ROM) 26, a random access memory (RAM) 28, a hard disk drive 30, a display driver 32 and display 34 and a user input/output (10) circuit 36 with a keyboard 38 and mouse 40. These devices are connected via a common bus 42. The computer 22 also Includes a graphics card 44 connected via the common bus 42. In this example, the graphics card is a Radeon X800XT visual processing unit manufactured by ATI Technologies Inc., Ontario Canada. The graphics card includes a graphics processing unit (GPU) and random access memory tightly coupled to the GPU (GPU memory) (not shown in FIG. 6).

The CPU 24 may execute program instructions stored within the ROM 26, the RAM 28, or the hard disk drive 30 to carry out processing of signal values associated with voxels of volume data that may be stored within the RAM 28 or the hard disk drive 30. The RAM 28 and hard disk drive 30 are collectively referred to as the system memory. The GPU may also execute program instructions to carry out processing of volume data passed to it from the CPU.

Thus a method for automatically determining a start or finish location near to an end of a lumen in a medical image data set has described. The location may thus be used in determining a camera path for virtual colonoscopy. The data set comprises a plurality of voxels arranged along first, second and third directions and the method includes: segmenting the data set to identify a group of voxels classified as belonging to the lumen; selecting one of the axes of the data set as a primary direction based on an expected direction of the lumen at the end of interest; selecting a slice through the data set which is perpendicular to the primary direction and includes voxels at a spatial extremity of the group of voxels classified as belonging to the lumen along this so direction; identifying a two-dimensional (2D) region of the voxels classified as belonging to the lumen within the selected slice; and selecting, based on the positions of the voxels comprising the 2D region within the data set, a position within the data set as the terminal location for the virtual colonoscopy camera path.

For use in a hospital environment, a computer system that implements the invention may usefully be integrated with a Picture Archiving and Communication System (PACS). This is a hospital-based computerised system which can store diagnostic images of different types (including three-dimensional volume data sets from CT, MR, PET and ultrasound scanners) in a digital format organised in a single central archive. Each image has associated patient information such as the name and date of birth of the patient also stored in the archive. The archive is connected to a computer network provided with a number of workstations, so that users all around the hospital site can access and view any image data as needed. Additionally, users remote from the site may be permitted to access the archive over the internet or a wide area network.

In the context of the present invention, therefore, a plurality of volume data sets can be stored in a PACS archive, and a computer-implemented method of calculating a starting point for virtual endoscopy according to of embodiments of the invention can be provided on a workstation connected to the archive via a computer network. The method may be performed on a local processor comprised within the workstation, or on a central processor located elsewhere in the network.

FIG. 11 shows an example computer network which can be used in conjunction with embodiments of the invention. The network 100 comprises a local area network in a hospital 102. The hospital 102 is equipped with a number of workstations 104 which each have access, via the local area network, to a hospital computer server 106 having an associated storage device (memory) 108. A PACS archive is stored on the storage device 108 so that data in the archive can be accessed from any of the workstations 104. One or more of the workstations 104 has access to software for computer-implementation of methods of calculating a starting point for virtual endoscopy as described above. The software may be stored locally at the or each workstation 104, or may be stored remotely and downloaded over the network 100 to a workstation 104 when needed. In another example, methods embodying the invention may be executed on the computer server 106 with the workstations 104 operating as terminals. A number of medical imaging devices 110, 112, 114, 116 are connected to the hospital computer server 106. Volume data collected with the devices 110, 112, 114, 116 can be stored directly into the PACS archive on the storage device 106. Thus a starting point for virtual endoscopy may be calculated immediately after the corresponding volume data set is recorded, so that swift further processing/display of images corresponding to the virtual endoscopy can be made to allow rapid diagnosis in the event of a medical emergency. The local area network 100 is connected to the Internet 118 by a hospital internet server 120, which allows remote access to the PACS archive. This is of use for remote accessing of the data and for transferring data between hospitals, for example, if a patient is moved or to allow external research to be undertaken.

It will be appreciated that although particular embodiments of the invention have been described, many modifications/additions and/or substitutions may be made within the scope of the present invention. Accordingly, the particular examples described are intended to be illustrative only, and not limitative.

### References

[1] U.S. Pat. No. 5,971,767
[2] U.S. Pat. No. 6,496,188
[3] U.S. Pat. No. 6,343,936
[4] U.S. Pat. No. 5,611,025
[5] US 2005/0033114
[6] US 2004/0202990
[7] WO 03/054803
[8] U.S. Pat. No. 5,782,762
[9] U.S. Pat. No. 6,083,162
[10] D. Bartz, “Virtual endoscopy in research and clinical practice”, STAR—State of the Art Report, Eurographics 2003, The Eurographics Association
[11] Wyatt, C. L., Ge, Y., Vining, D. J., Automatic Segmentation of the Colon for Virtual Colonoscopy, Computerized Medical Imaging and Graphics, 24, 1, 1-9, 2000.
[12] Frimmel H., Nappi. J., Yoshida, H., Centerline-based Colon Segmentation for CT Colonography, Medical Physics, 32, 8,2665-2672, August 2005
[13] Cormen, T. H., Leiserson, C. E., Rivest, R. L., Stein, C., Introduction to Algorithms, Second Edition. MIT Press and McGraw-Hill ISBN 0-262-03293-7. Chapter 21: Data structures for Disjoint Sets, pp.498-524, 2001

What is claimed is:

1. A method for automatically determining a terminal location for a virtual endoscopy camera path near an end of a lumen in a biological structure, the biological structure represented by a three-dimensional volume data set comprising a plurality of voxels arranged along first, second and third directions, the method comprising:
(a) segmenting the data set to identify a group of voxels classified as belonging to the lumen;
(b) selecting one of the first, second or third directions as a primary direction in accordance with an expected direction of the lumen at its end;
(c) selecting a slice through the data set which is perpendicular to the primary direction and includes voxels at a spatial extremity of the group of voxels classified as belonging to the lumen along this direction:
(d) identifying a two-dimensional (2D) region of the voxels classified as belonging to the lumen within the selected slice; and
(e) selecting a position within the data set as the terminal location for the virtual colonoscopy camera path based on the position of the 2D region in the data set.

2. A method according to claim 1, wherein the 2D region Identified in step (d) is the largest connected region of voxels classified as belonging to the lumen within the selected slice.

3. A method according to claim 1, wherein the position selected at step (e) as the terminal location for the virtual colonoscopy camera path is a position at tire centre of the 2D region

4. A method according to claim 1, further comprising a step (d1) between steps (d) and (e) of determining whether the 2D region of voxels identified in step (d) meets at least one pre-determined criterion, and if not, re-classifying the voxels in the 2D region in the selected slice as not belonging to the lumen, and returning to step (c) for another iteration based on the modified group of voxels classified as belonging to the lumen.

5. A method according to claim 4, wherein step (d1) further includes classifying all of the voxels in the selected slice as not belonging to the lumen in the event that the 2D region of voxels Identified in step (d) does not meet the at least one pre-determined criterion.

6. A method according to claim 4, wherein the at least one criterion is that the 2D region of voxels is larger than a threshold size.

7. A method according to claim 6, wherein the threshold size is chosen to be smaller than the expected size of the lumen, but larger than the typical size of a medical probe inserted into the lumen of interest during acquisition of the data set.

8. A method according to claim 4, wherein the at least one criterion is that the 2D region of voxels is located within a pre-determined portion of the selected slice.

9. A method according to claim 8, wherein the pre-determined portion is a central portion of the selected slice.

10. A method according to claim 8, wherein the pre-determined portion has a fractional area selected from the group consisting of 20%, 25%, 30%. 35%, 40%, 45% and 50% of the area of the selected slice.

11. A method according to claim 8, wherein the pre-determined portion is rectangular and has a dimension which is greater in a direction normal to a coronal plane in the data set than in a direction normal to a sagittal plane in the data set.

12. A method according to claim 1, wherein the biological structure is a colon.

13. A method according to claim 12, wherein the primary direction is a transverse direction in the data set.

14. A method according to claim 12, wherein fee end of the lumen corresponds to an anus.

15. A method of automatically determining a virtual endoscopy camera path, the method comprising determining a terminal location for the camera path according to claim 1, and calculating a camera path that starts or finishes at the terminal location.

16. A method of performing virtual endoscopy, the method comprising determining a virtual endoscopy camera path according to claim 15, and rendering a sequence of images of the lumen from viewpoints at different locations along the camera path, and displaying the sequence of images to a user.

17. A computer program product comprising machine readable instructions for implementing the method of claim 1.

18. A computer program product according to claim 17 comprising a computer program on a carrier medium.

19. A computer program product according to claim 17, wherein the carrier medium is a storage medium.

20. A computer program product according to claim 17, wherein the carrier medium is a transmissions medium.

21. A computer configured to perform the method of claim 1.

22. A network including a computer according to claim 21.

23. An apparatus for automatically determining a terminal location for a virtual endoscopy camera path near an end of a lumen in a biological structure, the biological structure represented by a three-dimensional volume data set comprising a plurality of voxels arranged along first, second and third directions, the apparatus comprising a processing unit coupled to a source of medical image data, wherein the processing unit is operable to:
(a) load a data set from the source of medical image data;
(a) segment the data set to identify a group of voxels classified as belonging to the lumen;
(b) select one of the first, second or third directions as a primary direction in accordance with an expected direction of the lumen at its end;
(c) select a slice through the data set which is perpendicular to the primary direction and includes voxels at a spatial extremity of the group of voxels classified as belonging to the lumen along this direction;
(d) identify a two-dimensional (2D) region of the voxels classified as belonging to the lumen within the selected slice; and
(e) select a position within the data set as the terminal location for the virtual colonoscopy camera path based on the position of the 2D region in the data set.
